(19) United States
(12) Patent Application Publication
(10) Pub. No.: US 2009/0225490 A1
(43) Pub. Date: Sep. 10, 2009

(54) CAPACITOR STRUCTURE

(76) Inventors: Tsuoe-Hsiang Liao, Hsin-Chu City (TW); Huo-Tieh Lu, Taipei City (TW); Yu-Fang Chien, Taipei County (TW); Chih-Chien Liu, Taipei City (TW); Pei-Lin Kuo, Taichung City (TW); Yu-Ru Yang, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 12/043,135

(22) Filed: Mar. 6, 2008

(51) Int. Cl. H01G 4/005; H01G 4/00

(52) U.S. Cl. 361/301.4; 361/303

(57) ABSTRACT

A capacitor structure has a first electrode and a second electrode, which does not electrically connect to the first electrode. The first electrode has a plurality of first meshed conductive structures. The first meshed conductive structures have the same layout pattern, and are electrically connected to each other. The second electrode has a plurality of second meshed conductive structures. The second meshed conductive structures have the same layout pattern, and are electrically connected to each other. The first meshed conductive structures and the second meshed conductive structures are alternately stacked.

### BACKGROUND OF THE INVENTION

1. Field of the Invention

The present invention relates to a capacitor structure, and more particularly, to a capacitor structure with a greater capacitance.

2. Description of the Prior Art

A capacitor, a device for storing charges, is normally adopted in various integrated circuits e.g. RFIC and analog circuits. Basically, a capacitor structure includes two opposite electrodes and a dielectric material disposed between the electrodes. The two electrodes are electrically connected to two different voltages, and are separated by the said dielectric material, so the capacitor has the functionality of storing electric charges. U.S. Pat. No. 6,822,312 discloses a conventional flat plate capacitor structures. Please refer to FIG. 1 to FIG. 3. FIG. 1 is a top view of a conventional interdigitated multilayer (IM) capacitor structure 20 according to U.S. Pat. No. 6,822,312; FIG. 2 is a perspective view of a section of the conventional IM capacitor structure 20 of FIG. 1; and FIG. 3 is an end view of the conventional IM capacitor structure 20 section of FIG. 2.

As shown in FIG. 1 and FIG. 2, the conventional IM capacitor structure 20 is constructed over a substrate 21 of semiconductor material in a multiple conductor level process. The first conductor level 11 includes a first parallel array of electrically conductive horizontal lines 22, the second conductor level 12 includes a second parallel array of electrically conductive horizontal lines 23, the third conductor level 13 includes a third parallel array of electrically conductive horizontal lines 24, and the fourth conductor level 14 includes a fourth parallel array of electrically conductive horizontal lines 25. A first dielectric layer (not shown) fills the space between the substrate 21 and the first conductor level 11; a second dielectric layer 27 fills the space between the first conductor level 11 and the second conductor level 12; a third dielectric layer 28 fills the space between the second conductor level 12 and the third conductor level 13; and a fourth dielectric layer 29 fills the space between the third conductor level 13 and the fourth conductor level 14.

The four levels 11, 12, 13, and 14 of conductive lines 22, 23, 24 and 25 are aligned over each other in vertical in rows or stacks. The conductive lines 22, 23, 24 and 25 in each row are electrically interconnected through vertically extending electrically conductive vias 30, 31 and 32 formed in the second, third, and fourth dielectric layers 27, 28 and 29. The rows of conductive lines 23, 24 and 25 and vias 30, 31 and 32 form a parallel array of vertically extending plates 33 which form the electrodes of the conventional IM capacitor structure 20. The vertically extending plates 33 are electrically interdigitated to opposite polarity by electrically connecting the top or bottom of the vertically extending plates 33 to a first common node A or a second common node B. The first node A and the second node B form the terminals of the conventional IM capacitor structure 20.

As shown in FIG. 3, the conventional IM capacitor structure 20 also has a total capacitance which is the sum of all the cross-over capacitance Cc between the vertically extending plates 33 (the sum of the cross-over capacitance between adjacent conductive lines and the cross-over capacitance between adjacent vias) and all the fringing capacitance Cf between the vertically extending plates 33. The quantity of cross-over capacitance Cc becomes a dominant factor in the capacitor's total capacitance, while the quantity of fringing capacitance Cf becomes much less significant.

However, the capacitor dielectric layer, and these vertically extending plates 33 of the conventional IM capacitor structure 20 are stacked up horizontally, and the overlapping region takes a large layout area for a needed capacitance. Therefore, the layout of the conventional IM capacitor structure 20 reduces the density of integration.

### SUMMARY OF THE INVENTION

It is therefore one object of the present invention to provide a capacitor structure with a greater capacitance.

From one aspect of the present invention, a capacitor structure is disclosed. The capacitor structure includes a first electrode, a second electrode and a dielectric material filling a space formed between the first electrode and the second electrode. The first electrode includes a plurality of first meshed conductive structures electrically connecting to each other. Each of the first meshed conductive structures has a layout pattern, and the layout patterns of the first meshed conductive structures are the same. The second electrode includes a plurality of second meshed conductive structures electrically connecting to each other. The first meshed conductive structures and the second meshed conductive structures are alternately stacked, and the first meshed conductive structures do not contact the second meshed conductive structures. Each of the second meshed conductive structures has a layout pattern, and the layout patterns of the second meshed conductive structures are the same.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The invention can be more fully understood by reading the following detailed description of the preferred embodiment, with reference made to the accompanying drawings as follows:

FIG. 1 is a top view of a conventional IM capacitor structure;

FIG. 2 is a perspective view of a section of the conventional IM capacitor structure of FIG. 1;

FIG. 3 is an end view of the conventional IM capacitor structure section of FIG. 2;

FIG. 4 shows a top-view schematic diagram of the capacitor structure according to the first preferred embodiment of the present invention;

FIG. 5 is a schematic diagram illustrating the layout pattern of the first conductive layer shown in FIG. 4;

FIG. 6 is a schematic diagram illustrating the layout pattern of the second conductive layer shown in FIG. 4;

FIG. 7 is a schematic diagram illustrating the layout pattern of the plug layer of the capacitor structure according to the first preferred embodiment of the present invention;

FIG. 8 shows a top-view schematic diagram of the capacitor structure according to the second preferred embodiment of the present invention;

FIG. 9 is a schematic diagram illustrating the layout pattern of the first conductive layer and the related plug layer of the capacitor structure according to the second preferred embodiment of the present invention;

FIG. 10 is a schematic diagram illustrating the layout pattern of the second conductive layer shown in FIG. 8;

FIG. 11 shows a top-view schematic diagram of the capacitor structure according to the third preferred embodiment of the present invention;

FIG. 12 is a schematic diagram illustrating the layout pattern of the first conductive layer and the related plug layer of the capacitor structure according to the third preferred embodiment of the present invention;

FIG. 13 is a schematic diagram illustrating the layout pattern of the second conductive layer shown in FIG. 11;

FIG. 14 shows a top-view schematic diagram of the capacitor structure according to the fourth preferred embodiment of the present invention;

FIG. 15 shows a top-view schematic diagram of the capacitor structure according to the fifth preferred embodiment of the present invention;

FIG. 16 is a schematic diagram illustrating the layout pattern of the first conductive layer and the related plug layer of the capacitor structure according to the fifth preferred embodiment of the present invention;

FIG. 17 shows a top-view schematic diagram of the capacitor structure according to the sixth preferred embodiment of the present invention;

FIG. 18 is a schematic diagram illustrating the layout pattern of the first conductive layer and the related plug layer of the capacitor structure according to the sixth preferred embodiment of the present invention;

FIG. 19 shows an oblique schematic diagram of the capacitor structure according to the seventh preferred embodiment of the present invention;

FIG. 20 shows an oblique schematic diagram of parts of the capacitor structure according to the eighth preferred embodiment of the present invention;

FIG. 21 shows a top-view schematic diagram of the capacitor structure according to the ninth preferred embodiment of the present invention;

FIG. 22 is a schematic diagram illustrating the layout pattern of the first conductive layer and the related plug layer of the capacitor structure according to the ninth preferred embodiment of the present invention;

FIG. 23 is a schematic diagram illustrating the layout pattern of the second conductive layer and the related plug layer of the capacitor structure according to the ninth preferred embodiment of the present invention; and

FIG. 24 is a schematic diagram illustrating the layout pattern of the third conductive layer shown in FIG. 21.

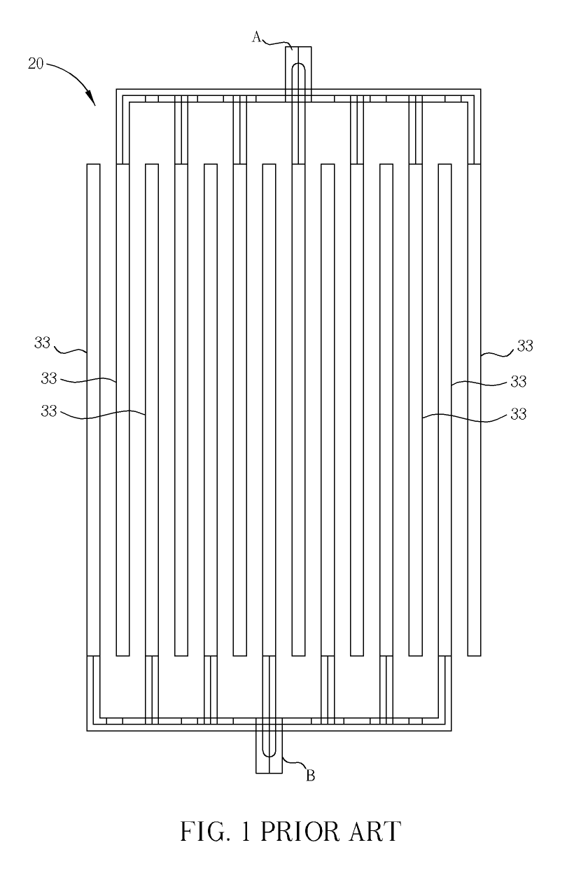

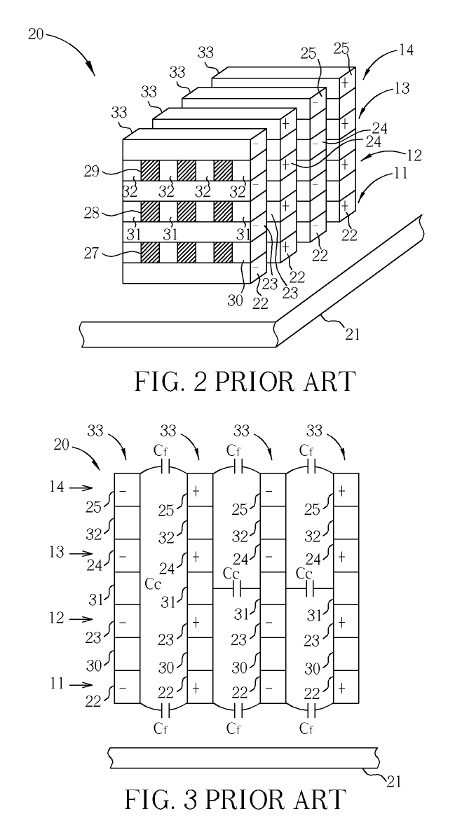

### DETAILED DESCRIPTION

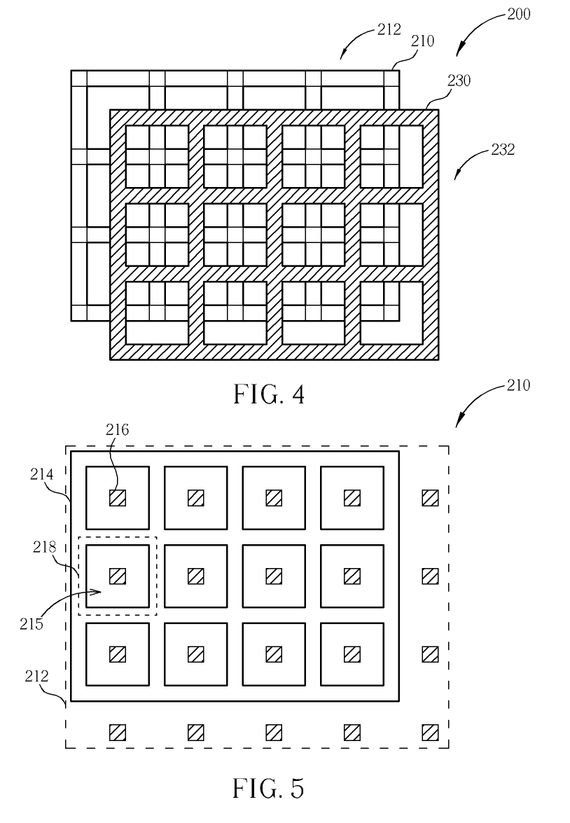

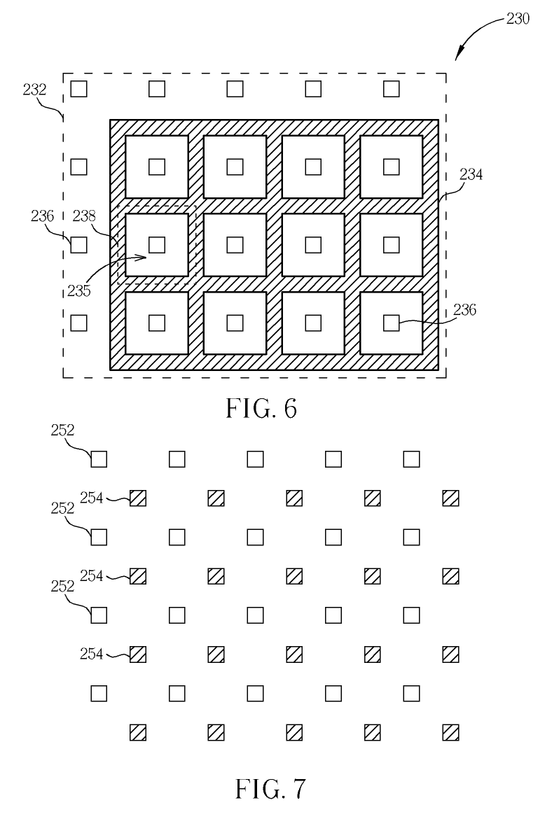

Please refer to FIG. 4 to FIG. 7. FIG. 4 shows a top-view schematic diagram of the capacitor structure 200 according to the first preferred embodiment of the present invention; FIG. 5 is a schematic diagram illustrating the layout pattern of the first conductive layer 210 shown in FIG. 4; FIG. 6 is a schematic diagram illustrating the layout pattern of the second conductive layer 230 shown in FIG. 4; and FIG. 7 is a schematic diagram illustrating the layout pattern of the plug layer of the capacitor structure 200 according to the first preferred embodiment of the present invention, where like numbered numerals designate similar or the same parts, regions or elements. It is to be understood that the drawings are not drawn to scale and are served only for illustration purposes. It is appreciated that the capacitor structure 200 of the present invention is not limited to a two-layer structure formed by stacking the first conductive layer 210 and the second conductive layer 230, and can be a multi-layer structure including at least three conductive layers, such as a four-layer stacked structure or a six-layer stacked structure. For a multi-layer structure, the layout pattern of a conductive pattern of an odd layer can be identical to the conductive pattern 212 of the first conductive layer 210, and the layout pattern of a conductive pattern of an even layer can be identical to the conductive pattern 232 of the second conductive layer 230.

As shown in FIG. 4, the capacitor structure 200 includes at least a first conductive layer 210 and at least a second conductive layer 230 disposed on the first conductive layer 210. Both the conductive pattern 212 of the first conductive layer 210 and the conductive pattern 232 of the second conductive layer 230 include conductive rectangular mesh. As shown in FIG. 5, the first conductive layer 210 has a conductive pattern 212, and the conductive pattern 212 includes at least a meshed conductive structure 214 and a plurality of conductive islands 216. The meshed conductive structure 214 can be formed by a plurality of rectangular conductive rings 218, and each rectangular conductive ring 218 can form a rectangular mesh 215 respectively. Each conductive island 216 can be disposed in each rectangular mesh 215 and does not contact the meshed conductive structure 214. The meshed conductive structure 214 can be electrically connected to a first voltage (not shown in the drawings) as a part of the first electrode of the capacitor structure 200, while all the conductive islands 216 are electrically connected to a second voltage (not shown in the drawings) as a part of the second electrode of the capacitor structure 200. For example, the first voltage and the second voltage can be a positive voltage and a negative voltage.

As shown in FIG. 6, the second conductive layer 230 has a conductive pattern 232. The conductive pattern 232 includes at least a meshed conductive structure 234 and a plurality of conductive islands 236. The meshed conductive structure 234 can also be formed by a plurality of rectangular conductive rings 238, and each rectangular conductive ring 238 can form a rectangular mesh 235 respectively. In this embodiment, the conductive pattern 232 and the conductive pattern 212 have the same pattern shape but different orientations (rotated 180 degrees). Thus, the layout pattern of the meshed conductive structure 234 and the layout pattern of the meshed conductive structure 214 can be the same, and the meshed conductive structure 234 is staggered from the meshed conductive structure 214. Each conductive island 236 can be disposed in each rectangular mesh 235 and does not contact the meshed conductive structure 234. In contrast between FIG. 4 and FIG. 5, the conductive islands 236 can correspond to corners of the rectangular conductive rings 218 of the meshed conductive structure 214, while the corners of the rectangular conductive rings 238 of the meshed conductive structure 234 can correspond to the conductive islands 216.

As shown in FIG. 7, the capacitor structure 200 further has a plugs layer disposed between the first conductive layer 210 and the second conductive layer 230. The plugs layer includes a plurality of plugs 252 and a plurality of plugs 254, such as via plugs or contact plugs. In this embodiment, the plugs 252 can be disposed right under each conductive island 236. The plugs 252 can contact and electrically connect the meshed conductive structure 214, such as the corners of the rectangular conductive rings 218, and the conductive islands 236. In addition, the plugs 254 can be disposed right above each conductive island 216, contacting and electrically connecting the meshed conductive structure 234, such as the corners of the rectangular conductive rings 238, and the conductive islands 216.

In this embodiment, the second conductive layer 230 and the first conductive layer 210 have similar layout patterns, and the conductive pattern 232 and the conductive pattern 212 are arranged in different orientations. As a result, the meshed conductive structure 214 is staggered from the meshed conductive structure 234. Specifically speaking, there are two offsets between the position of the meshed conductive structure 234 and the position of the meshed conductive structure 214 in two directions along the length and the width of the rectangular conductive ring 218 respectively. Thus, the meshed conductive structure 234 of the second conductive layer 230, the conductive islands 216 of the first conductive layer 210, and the plugs 254 disposed between the meshed conductive structure 234 and the conductive islands 216 are electrically connected to each other as the second electrode of the capacitor structure 200. On the other hand, the conductive islands 236 of the second conductive layer 230, the meshed conductive structure 214 of the first conductive layer 210, and the plugs 252 disposed between the meshed conductive structure 214 and the conductive islands 236 are electrically connected to each other as the first electrode of the capacitor structure 200.

Accordingly, the capacitor structure 200 of the present invention can provide a grater capacitance in the unit volume. The capacitance of the capacitor structure 200 is contributed to by the vertical capacitance between the first conductive layer 210 and the second conductive layer 230, the horizontal capacitance between the meshed conductive structure 214 and the conductive islands 216, the horizontal capacitance between the meshed conductive structure 234 and the conductive islands 236, and the horizontal capacitance between the plugs 252 and the plugs 254.

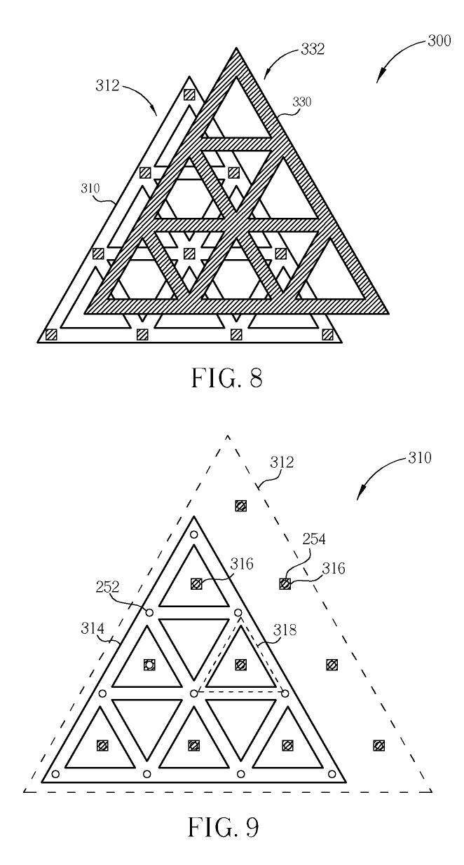

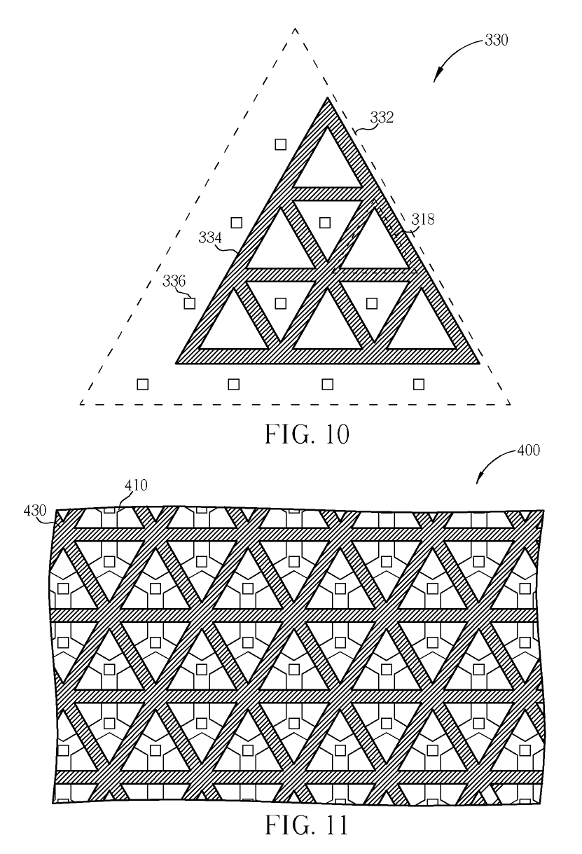

One of the characteristics of the present invention is that the electrode of the capacitor structure has the meshed conductive structure, and there are conductive islands having different polarities inside the meshed conductive structure to provide the horizontal capacitance. It should be noted that the layouts and the shapes of the conductive patterns and the plugs should not be limited to the above-mentioned embodiment, and the layouts and the shapes can be adjusted to be various shapes, such as triangular shape, circular shape, pentagonal shape, hexagonal shape, octagonal shape or parallelogram. Please refer to FIG. 8 to FIG. 10. FIG. 8 shows a top-view schematic diagram of the capacitor structure 300 according to the second preferred embodiment of the present invention; FIG. 9 is a schematic diagram illustrating the layout pattern of the first conductive layer 310 and the related plug layer of the capacitor structure 300 according to the second preferred embodiment of the present invention; and FIG. 10 is a schematic diagram illustrating the layout pattern of the second conductive layer 330 shown in FIG. 8, where like numbered numerals designate similar or the same parts, regions or elements. As shown in FIG. 8, it is a difference from the first embodiment that both the conductive pattern 312 of the first conductive layer 310 and the conductive pattern 332 of the conductive layer second 330 include conductive triangular meshes 314, 334 in the second embodiment.

As shown in FIG. 9, the first conductive layer 310 has a conductive pattern 312, and the conductive pattern 312 includes at least a meshed conductive structure 314 and a plurality of conductive islands 316. The meshed conductive structure 314 can be formed by a plurality of triangular conductive rings 318.

As shown in FIG. 10, the second conductive layer 330 has a conductive pattern 332, and the conductive pattern 332 includes at least a meshed conductive structure 334 and a plurality of conductive islands 336. The second conductive layer 230 and the first conductive layer 210 have similar layout patterns, and the meshed conductive structure 334 is staggered from the meshed conductive structure 314. For instance, there are two offsets between the position of the meshed conductive structure 334 and the position of the meshed conductive structure 314 in two directions along two edges of the triangular conductive ring 318 respectively. As a result, the conductive islands 336 can correspond to corners of the triangular conductive rings 318 of the meshed conductive structure 314, while the corners of the triangular conductive rings 318 of the meshed conductive structure 334 can correspond to the conductive islands 316.

In contrast among FIG. 8, FIG. 9 and FIG. 10, each conductive island 316 of the first conductive layer 310 can contact at least a plug 254 thereon, and each conductive island 336 of the second conductive layer 330 can contact at least an underlying plug 252. Thus, the meshed conductive structure 334 of the second conductive layer 330, the conductive islands 316 of the first conductive layer 310, and the plugs 254 disposed between the meshed conductive structure 334 and the conductive islands 316 are electrically connected to each other as the second electrode of the capacitor structure 300. On the other hand, the conductive islands 336 of the second conductive layer 330, the meshed conductive structure 314 of the first conductive layer 310, and the plugs 252 disposed between the meshed conductive structure 314 and the conductive islands 336 are electrically connected to each other as the first electrode of the capacitor structure 300.

In the above two embodiments, the meshed conductive structures, which are vertically adjacent, have the similar layout patterns and are staggered from each other. In order to take more advantage of the space in the integrated circuit, the meshed conductive structures, which are vertically adjacent, can have different layout patterns in other embodiments of the present invention. Accordingly, there can be at least a conductive island in each conductive ring to effectively increase the electrode area of the capacitor structure. Please refer to FIG. 11 to FIG. 13. It is a difference from the second embodiment that the conductive pattern of the first conductive layer 410 includes conductive hexagonal meshes in the third embodiment.

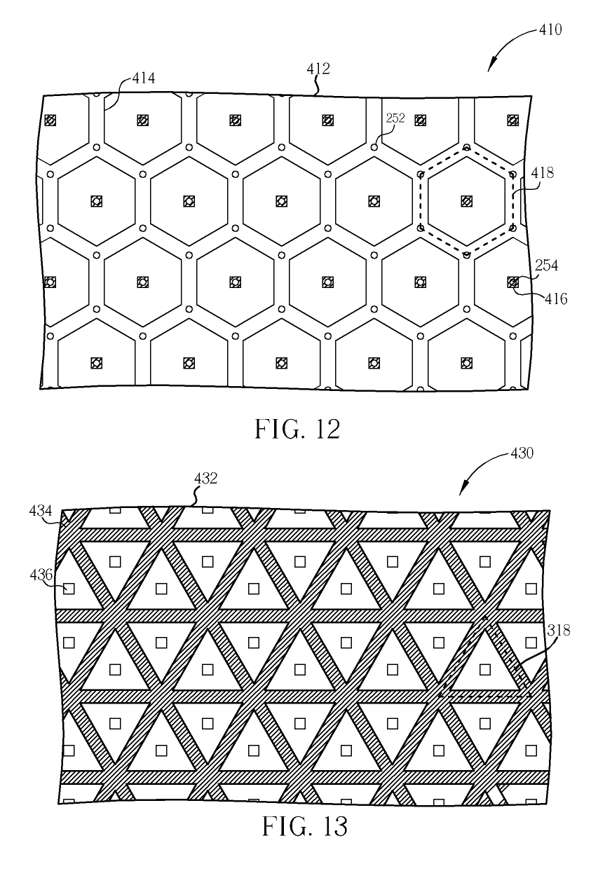

As shown in FIG. 12, the first conductive layer 410 has a conductive pattern 412, and the conductive pattern 412 includes at least a meshed conductive structure 414 and a plurality of conductive islands 416. The meshed conductive structure 414 can be formed by a plurality of hexagonal conductive rings 418. Each hexagonal conductive ring 418 can form a hexagonal mesh respectively. Each conductive island 416 can be disposed in each hexagonal mesh and does not contact the meshed conductive structure 414.

As shown in FIG. 13, the second conductive layer 430 has a conductive pattern 432, and the conductive pattern 432 includes at least a meshed conductive structure 434 and a plurality of conductive islands 436. The meshed conductive structure 434 can be formed by a plurality of triangular conductive rings 318, and each triangular conductive ring 318 can form a triangular mesh respectively. Each conductive island 436 can be disposed in each triangular mesh and does not contact the meshed conductive structure 434. For example, the conductive islands 436 can correspond to corners of the hexagonal conductive rings 418 of the meshed conductive structure 414, while corners of the triangular conductive rings 318 can correspond to the conductive islands 416.

In addition, in contrast between FIG. 12 and FIG. 13, the capacitor structure 400 has a plug layer disposed between the first conductive layer 410 and the second conductive layer 430. The meshed conductive structure 434 of the second conductive layer 430, the conductive islands 416 of the first conductive layer 410, and the plugs 254 disposed between the meshed conductive structure 434 and the conductive islands 416 are electrically connected to each other as the second electrode of the capacitor structure 400. On the other hand, the conductive islands 436 of the second conductive layer 430, the meshed conductive structure 414 of the first conductive layer 410, and the plugs 252 disposed between the meshed conductive structure 414 and the conductive islands 436 are electrically connected to each other as the first electrode of the capacitor structure 400.

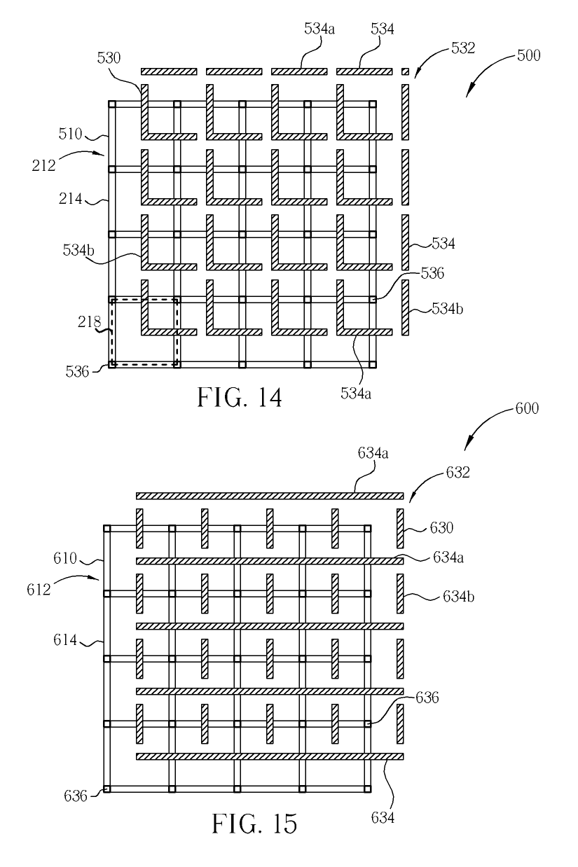

Furthermore, the conductive patterns of the capacitor structure should not be limited to the conductive pattern including merely the meshed conductive structure and the conductive islands in the present invention. In practice, the conductive patterns can further include conductive structures having other shapes. For example, the conductive pattern of some layers can further include conductive bars. Please refer to FIG. 14, which shows a top-view schematic diagram of the capacitor structure 500 according to the fourth preferred embodiment of the present invention. It is a difference from the first embodiment that many major conductive bars 534 are included in the fourth embodiment in place of the meshed conductive structure 234 of the first embodiment. Comparing with the continuous meshed structure, the conductive bars can decrease the structural stress of the capacitor structure.

As shown in FIG. 14, the second conductive layer 530 has a conductive pattern 532, and the conductive pattern 532 includes a plurality of major conductive bars 534 and a plurality of conductive islands 536. Some of the major conductive bars 534a can be parallel with the length direction of the rectangular conductive ring 218 of the first conductive layer 510, and some of the major conductive bars 534b are parallel with the width direction of the rectangular conductive ring 218 of the first conductive layer 510. A major conductive bar 534a and a major conductive bar 534b can form a separated conductive structure having a L-shape. The conductive islands 536 can correspond to corners of the rectangular conductive ring 218 of the meshed conductive structure 214, while the intersections of the major conductive bars 534a and the major conductive bars 534b can correspond to the conductive islands (not shown in the drawings) of the first conductive layer 510. The major conductive bars 534 can be disposed around each conductive island 536.

Accordingly, the conductive islands 536 do not contact the major conductive bars 534. The conductive islands 536 can be electrically connected to the meshed conductive structure 214 through the underlying plugs (not shown in the drawings) to form the first electrode of the capacitor structure 500. Meanwhile, the conductive islands (not shown in the drawings) of the first conductive layer 510 can be electrically connected to the major conductive bars 534 through the upper plugs (not shown in the drawings) to form the second electrode of the capacitor structure 500.

In addition, the major conductive bars 534 of the second conductive layer 530 can have other layout arrangements in other embodiments of the present invention. Please refer to FIG. 15 to FIG. 18.

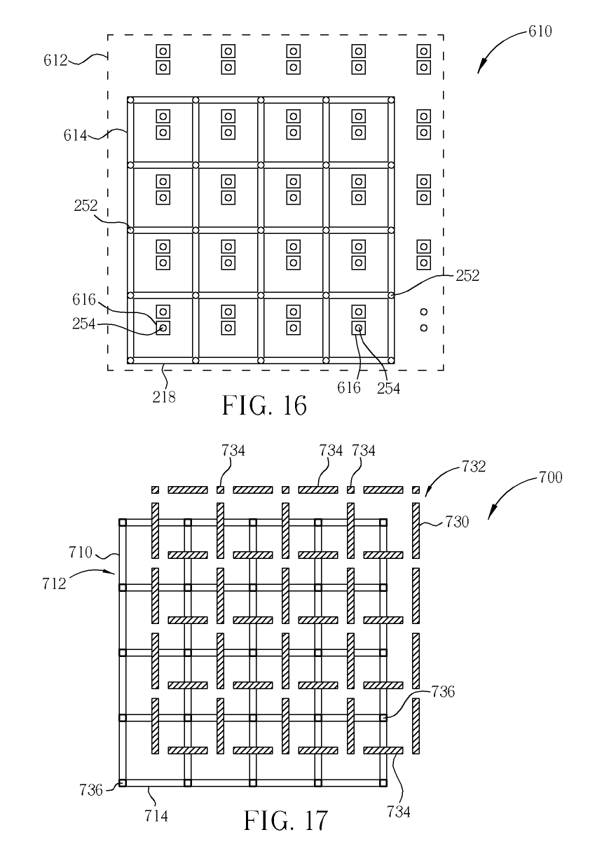

As FIG. 15 and FIG. 16 show, the first conductive layer 610 has a conductive pattern 612, and the conductive pattern 612 includes at least a meshed conductive structure 614 and a plurality of conductive islands 616. The second conductive layer 630 has a conductive pattern 632, and the conductive pattern 632 includes a plurality of the major conductive bars 634 and a plurality of conductive islands 636. Some of the major conductive bars 634a can be parallel with the length direction of the rectangular conductive rings 218 of the first conductive layer 610, and the major conductive bars 634a can be abreast of each other. Some of the major conductive bars 634b can be disposed between the conductive bars 634, be parallel with the width direction of the rectangular conductive rings 218 of the first conductive layer 610, and be abreast of each other. Each of the major conductive bars 634 can correspond to at least an underlying plug 254, each of the plugs 254 can correspond to an underlying conductive island 616, and each of the major conductive bars 634, each of the plugs 254, and each of the conductive islands 616 can be electrically connected to the second voltage to form the second electrode of the capacitor structure 600. On the other hand, the conductive islands 636 can be electrically connected to the meshed conductive structure 614 through of the underlying plugs 252 to form the first electrode of the capacitor structure 600.

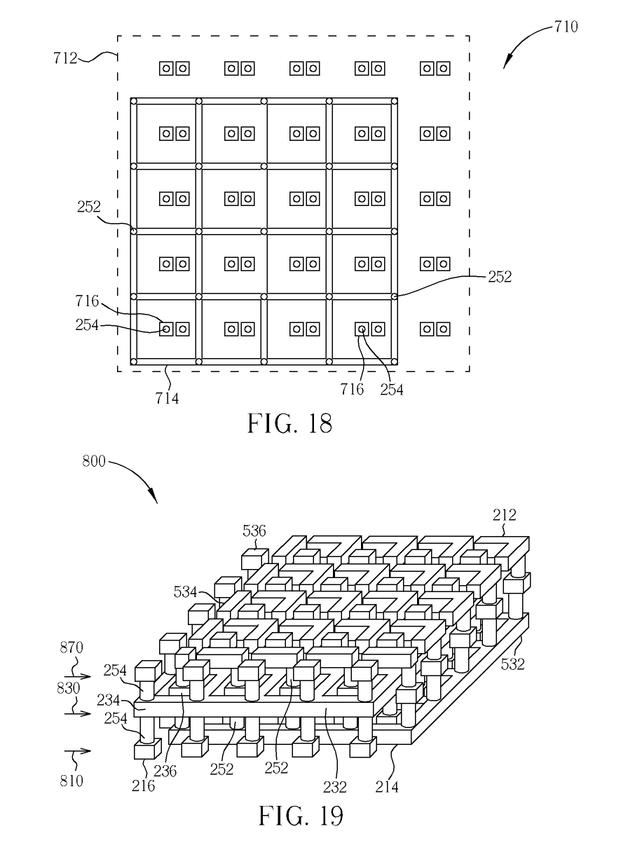

As shown in FIG. 17 and FIG. 18, the first conductive layer 710 has a conductive pattern 712, and the conductive pattern 712 includes at least a meshed conductive structure 714 and a plurality of conductive islands 716. The second conductive layer 730 has a conductive pattern 732, and the conductive pattern 732 includes a plurality of the major conductive bars 734 and a plurality of conductive islands 736. Each of the major conductive bars 734 can correspond to an underlying plug 254, each of the plugs 254 can correspond to an underlying conductive island 716, and each of the major conductive bars 734, each of the plugs 254, and each of the conductive islands 716 can be electrically connected to the second voltage to form the second electrode of the capacitor structure 700. On the other hand, the conductive islands 736 can be electrically connected to the meshed conductive structure 714 through of the underlying plugs 252 to form the first electrode of the capacitor structure 700.

As the mentioned above, the capacitor structure of the present invention is not limited to a two-layer structure formed by stacking the first conductive layer and the second conductive layer, and can be a multi-layer structure, such as a three-layer stacked structure formed by stacking the first, the second and the third conductive layers. Please refer to FIG. 19, which shows an oblique schematic diagram of the capacitor structure 800 according to the seventh preferred embodiment of the present invention, where like numbered numerals designate similar or the same parts, regions or elements.

As shown in FIG. 19, the capacitor structure 800 includes at least a first conductive layer 810, at least a second conductive layer 830 and at least a third conductive layer 870. The second conductive layer 830 is disposed on the first conductive layer 810, and the third conductive layer 870 is disposed on the second conductive layer 830. The conductive pattern of the first conductive layer 810, the conductive pattern of the second conductive layer 830 and the conductive pattern of the third conductive layer 870 in the seventh embodiment can be identical to the conductive pattern 212 of the first conductive layer 210 in the first embodiment, the conductive pattern 232 of the second conductive layer 230 in the first embodiment, and the conductive pattern 532 of the second conductive layer 530 in the fourth embodiment respectively. Accordingly, the plugs 252 and the plugs 254 disposed between the first conductive layer 810 and the second conductive layer 830 in the seventh embodiment can be identical to the plugs 252 and the plugs 254 of the first embodiment, and the plugs 252 and the plugs 254 disposed between the second conductive layer 830 and the third conductive layer 870 in the seventh embodiment can be identical to the plugs 252 and the plugs 254 of the fourth embodiment.

The meshed conductive structure 214 of the first conductive layer 810, the conductive islands 236 of the second conductive layer 830, the major conductive bars 534 of the third conductive layer 870, and the plugs 252 disposed between them are electrically connected to each other to form the first electrode of the capacitor structure 800. On the other hand, the conductive islands 216 of the first conductive layer 810, the meshed conductive structure 234 of the second conductive layer 830, the conductive islands 536 of the third conductive layer 870, and the plugs 254 disposed between them are electrically connected to each other to form the second electrode of the capacitor structure 800.

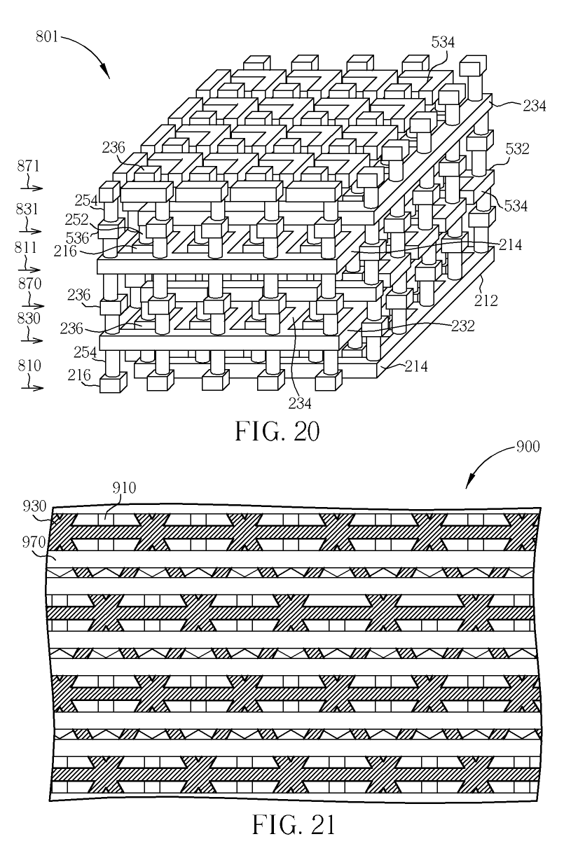

Since the capacitor structure 800 is an odd-layer structure formed by stacking the first, the second and the third conductive layers, it appreciated that the meshed conductive structures of odd layers can be staggered to the meshed conductive structures of even layers when more conductive layers are stacked above to increase the capacitance. Accordingly, the meshed conductive structures of odd layers can be electrically connected to each other vertically, and the meshed conductive structures of even layers can also be electrically connected to each other vertically. Thus, the capacitance can be improved, and the capacitor structure can have a good matching structure. Please refer to FIG. 20, which shows an oblique schematic diagram of parts of the capacitor structure 801 according to the eighth preferred embodiment of the present invention, where like numbered numerals designate similar or the same parts, regions or elements. It is worthy of note that the dialectical material of the capacitor structure, some of the conductive islands and some of the plugs are omitted in FIG. 20 for clearly illustrating the relative positions among the meshed conductive structure and the major conductive bars, so only the meshed conductive structures, the major conductive bars, some of the conductive islands and some of the plugs of the capacitor structure 801 are shown in FIG. 20.

As shown in FIG. 20, the capacitor structure 801 includes at least a first conductive layer 810, at least a second conductive layer 830, at least a third conductive layer 870, at least a fourth conductive layer 811, at least a fifth conductive layer 831 and at least a sixth conductive layer 871 from bottom to top. The conductive pattern of the fourth conductive layer 811, the conductive pattern of the fifth conductive layer 831, and the conductive pattern of the sixth conductive layer 871 can be identical to the conductive pattern 212, the conductive pattern 232 and the conductive pattern 532 respectively. The meshed conductive structure 214 of the fourth conductive layer 811 is staggered from the meshed conductive structure 214 of the first conductive layer 810; the meshed conductive structure 234 of the fifth conductive layer 831 is staggered from the meshed conductive structure 234 of the second conductive layer 830; and the major conductive bars 534 of the sixth conductive layer 871 are staggered from the major conductive bars 534 of the third conductive layer 870.

The meshed conductive structure 214 of the first conductive layer 810, the conductive islands 236 of the second conductive layer 830, the major conductive bars 534 of the third conductive layer 870, the conductive islands 216 of the fourth conductive layer 811, the meshed conductive structure 234 of the fifth conductive layer 831, the conductive islands 236 of the sixth conductive layer 871, and the plugs 252 disposed between them are electrically connected to each other to form the first electrode of the capacitor structure 801. On the other hand, the conductive islands 216 of the first conductive layer 810, the meshed conductive structure 234 of the second conductive layer 830, the conductive islands 536 of the third conductive layer 870, the meshed conductive structure 214 of the fourth conductive layer 811, the conductive islands 236 of the fifth conductive layer 831, the major conductive bars 534 of the sixth conductive layer 871, and the plugs 254 disposed between them are electrically connected to each other to form the second electrode of the capacitor structure 800.

In other embodiments of the present invention, the first conductive layer, the second conductive layer and the third conductive layer can have three different conductive patterns respectively. Please refer to FIG. 21 to FIG. 24.

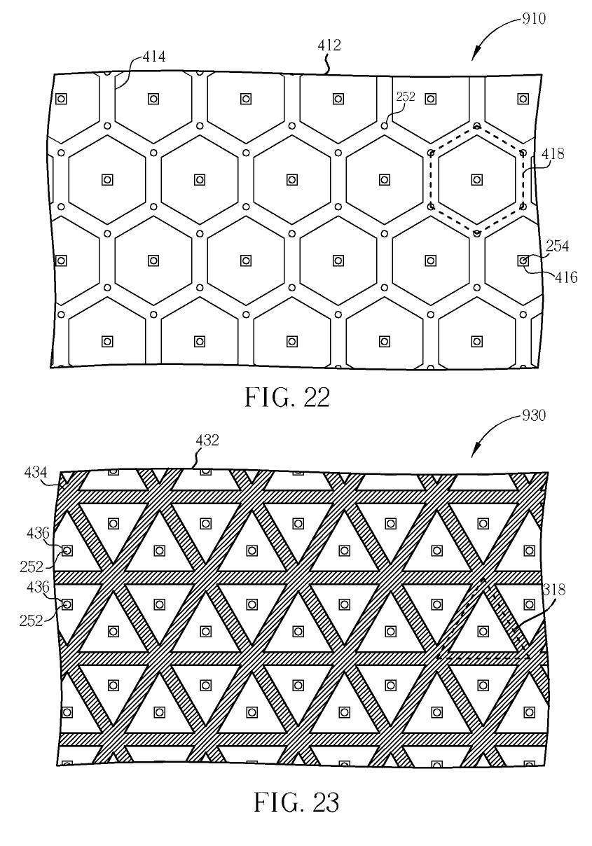

As shown in FIG. 21, the capacitor structure 900 includes a first conductive layer 910 and a second conductive layer 930 and a third conductive layer 970 from bottom to top. As shown in FIG. 22 and FIG. 23, the conductive pattern of the first conductive layer 910 and the conductive pattern of the second conductive layer 930 in the ninth embodiment can be identical to the conductive pattern of the first conductive layer 410 and the conductive pattern of the conductive layer 430 in the third embodiment respectively. Accordingly, the plugs 252 and the plugs 254 disposed between the first conductive layer 910 and the second conductive layer 930 in the ninth embodiment can have same layout pattern with the plugs 252 and the plugs 254 in the third embodiment.

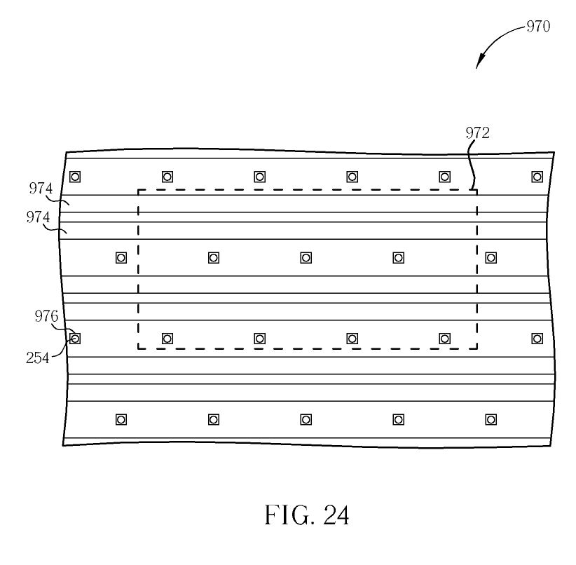

As shown in FIG. 24, the third conductive layer 970 has a conductive pattern 972, and the conductive pattern 972 includes a plurality of major conductive bars 974, which are parallel with each other, and a plurality of conductive islands 976. In contrast among FIG. 21, FIG. 22, FIG. 23 and FIG. 24, the major conductive bars 974 of the third conductive layer 970 can correspond to the conductive islands 436 of the second conductive layer 430, and each conductive island 976 of the third conductive layer 970 can correspond to each conductive island 416 of the first conductive layer 410 respectively.

Accordingly, each of the major conductive bars 974 of the third conductive layer 970 can be electrically connected to the conductive islands 436 of the second conductive layer 930 through the underlying plugs 252, and each of the conductive islands 436 of the second conductive layer 930 can be electrically connected to the meshed conductive structure 414 of first conductive layer 410 through the underlying plugs 252 to form the first electrode of the capacitor structure 900. On the other hand, each of the conductive islands 976 of the third conductive layer 970 can be electrically connected to the meshed conductive structure 434 of the second conductive layer 930 through the underlying plugs 254, the meshed conductive structure 434 of the second conductive layer 930 can be electrically connected to the conductive islands 416 of the first conductive layer 410 through the underlying plugs 254 to form the second electrode of the capacitor structure 900.

Thus, the shape, size, and arranged density of the plugs are not limited by the above-mentioned configurations and can be modified to obtain an optimal capacitance and a great matching. It should be understood by a person skilled in the art that the present invention can further include a dielectric material or a plurality of dielectric layers (not shown in the drawings) to fill a space between the first electrode and the second electrode as the dielectric layer of the capacitor structure. However, for clearly illustrating the electrode structure of the present invention, the dielectric material is not shown in the drawings. Furthermore, the capacitor structure of the present invention can include two I/O ports (not shown in the drawings) for external connections. In addition, the fabrication of the capacitor structure of the present invention can be integrated into the metal interconnection process. In such a case, the conductive pattern can be made from metal materials e.g. aluminum or copper, or other conductive materials, such as polycrystalline silicon. The material of the contact plugs can be tungsten, copper, aluminum, etc. The dielectric layer may be silicon oxide, silicon nitride, silicon oxynitride, or any single or composite dielectric materials.

The capacitance of the capacitor is contributed by the vertical capacitance between the conductive patterns, the horizontal capacitance between the meshed conductive structures and the conductive islands in each layer, the horizontal capacitance between the major conductive bars and the conductive islands in each layer, and the horizontal capacitance between the plugs, and therefore the capacitance of the capacitor structure in unit volume can be effectively improved.

Those skilled in the art will readily observe that numerous modifications and alterations of the device and method may be made while retaining the teachings of the invention.

What is claimed is:

1. A capacitor structure, comprising:
a first electrode, comprising a plurality of first meshed conductive structures electrically connecting to each other, each of the first meshed conductive structures having a layout pattern, the layout patterns of the first meshed conductive structures being the same;
a second electrode, comprising a plurality of second meshed conductive structures electrically connecting to each other, the first meshed conductive structures and the second meshed conductive structures being alternately stacked, the first meshed conductive structures not contacting the second meshed conductive structures, each of the second meshed conductive structures having a layout pattern, the layout patterns of the second meshed conductive structures being the same; and
a dielectric material filling a space formed between the first electrode and the second electrode.

2. The capacitor structure of claim 1, wherein the layout patterns of the first meshed conductive structures and the layout patterns of the second meshed conductive structures are the same, and the first meshed conductive structures are staggered from the second meshed conductive structures.

3. The capacitor structure of claim 2, wherein each of the first and second meshed conductive structures has a plurality of triangular meshes.

4. The capacitor structure of claim 3, wherein the first electrode further comprises a plurality of first conductive islands, and the first conductive islands are disposed in the triangular meshes of the second meshed conductive structures.

5. The capacitor structure of claim 4, wherein the first electrode further comprises a plurality of first plugs, and the first meshed conductive structures are electrically connected to each other through the first conductive islands and the first plugs.

6. The capacitor structure of claim 1, wherein each of the first meshed conductive structures has a plurality of hexagonal meshes, and each of the second meshed conductive structures has a plurality of triangular meshes.

7. The capacitor structure of claim 6, wherein the first electrode further comprises a plurality of the first conductive islands, and the first conductive islands are disposed in the triangular meshes of the second meshed conductive structures.

8. The capacitor structure of claim 7, wherein the first electrode further comprises a plurality of first plugs, and the first meshed conductive structures are electrically connected to each other through the first conductive islands and the first plugs.

9. The capacitor structure of claim 6, wherein the second electrode further comprises a plurality of second conductive islands, and the second conductive islands are disposed in the hexagonal meshes of the first meshed conductive structures.

10. The capacitor structure of claim 7, wherein the second electrode further comprises a plurality of second plugs, and the second meshed conductive structures are electrically connected to each other through the second conductive islands and the second plugs.

11. A capacitor structure, comprising:
at least a first conductive layer, having a first conductive pattern, the first conductive pattern comprising at least a first meshed conductive structure and a plurality of first conductive islands, the first meshed conductive structure having a plurality of first meshes, the first conductive islands being disposed in the first meshes and not contacting the first meshed conductive structure, the first meshed conductive structure being electrically connected to a first voltage, the first conductive islands being electrically connected to a second voltage; and
at least a second conductive layer disposed on the first conductive layer, having a second conductive pattern, the second conductive pattern being electrically connected to the first conductive islands of the first conductive pattern, and the second conductive pattern being different from the first conductive pattern.

12. The capacitor structure of claim 11, wherein the second conductive pattern comprises a plurality of second major conductive bars and a plurality of second conductive islands, the second major conductive bars are electrically connected to the first conductive islands of the first conductive layer, and the second conductive islands are electrically connected to the first meshed conductive structure of the first conductive layer.

13. The capacitor structure of claim 12, wherein the first meshed conductive structure has a plurality of rectangular conductive rings, each of the rectangular conductive rings forms each of the first meshes respectively, the second conductive islands are disposed above the rectangular conductive rings and correspond to corners of the rectangular conductive rings.

14. The capacitor structure of claim 12, further comprising:
at least a third conductive layer disposed on the second conductive layer, having a third conductive pattern, the third conductive pattern comprising at least a third meshed conductive structure and a plurality of third conductive islands, the third meshed conductive structure having a plurality of third meshes, the third conductive islands are disposed in the third meshes and not contacting the third meshed conductive structure, the third meshed conductive structure being electrically connected to the second conductive islands of the second conductive layer, and the third conductive islands being electrically connected to the second major conductive bars of the second conductive layer.

15. The capacitor structure of claim 14, wherein the first and the third meshed conductive structures have a plurality of rectangular conductive rings respectively, each of the rectangular conductive rings forms each of the first and the third mesh respectively, and the second conductive islands correspond to corners of the rectangular conductive rings.

16. The capacitor structure of claim 15, wherein a layout pattern of the first meshed conductive structure and a layout pattern of the second meshed conductive structure are the same, and the first meshed conductive structure corresponds to the third meshed conductive structure.

17. The capacitor structure of claim 14, further comprising:
at least a fourth conductive layer disposed on the third conductive layer, comprising at least a fourth meshed conductive structure, a layout pattern of the fourth meshed conductive structure and a layout pattern of the first meshed conductive structure being the same, and the fourth meshed conductive structure are staggered from the first meshed conductive structure.

18. A capacitor structure, comprising:
at least a first conductive layer, comprising at least a first meshed conductive structure and a plurality of first conductive islands, the first meshed conductive structure having a plurality of hexagonal meshes, the first conductive islands being disposed in the hexagonal meshes and not contacting the first meshed conductive structure, the first meshed conductive structure being electrically connected to a first voltage, the first conductive islands being electrically connected to a second voltage;
at least a second conductive layer disposed on the first conductive layer, comprising at least a second meshed conductive structure and a plurality of second conductive islands, the second meshed conductive structure having a plurality of triangular meshes, the second conductive islands are disposed in the triangular meshes and not contacting the second meshed conductive structure, the second meshed conductive structure being electrically connected to the first conductive islands, and the second conductive islands being electrically connected to the first meshed conductive structure;
at least a third conductive layer disposed on the second conductive layer, comprises a plurality of third major conductive bars and a plurality of third conductive islands, the third major conductive bars being electrically connected to the second conductive islands, and the third conductive islands are electrically connected to the second meshed conductive structure.
